(19) United States
(12) Patent Application Publication
(10) Pub. No.: US 2003/0050901 A1
(43) Pub. Date: Mar. 13, 2003

(54) Method and system for automating price discovery for cash trade in tangible commodities

(76) Inventors: Thomas Eugene Jester, Peoria, IL (US); Steven Grant Price, Sycamore, IL (US); Mark Edward Rubin, Lombard, IL (US); Gregory Marcinko, McHenry, IL (US)

Correspondence Address: PATRICIA SMITH KING, SUITE 22, 222 NORTH MIDVALE BOULEVARD, MADISON, WI, 537055072

(21) Appl. No.: 10/237,385

(22) Filed: Sep. 9, 2002

Related U.S. Application Data
(60) Provisional application No. 60/317,761, filed on Sep. 7, 2001.

(51) Int. Cl. G06G 7/00

(52) U.S. Cl. 705/400

(57) ABSTRACT

The present invention is directed to an on-line method and system for automating price discovery for cash trade in tangible agricultural commodities with physical delivery requirements, in real-time among a network clients authorized to conduct business with one another, the clients comprising buyers, sellers and resellers. Communications and offers are restricted to client groups with established business relationships to insure confidentiality. Clients input data including basis amounts and live data feed of futures prices is provided, to enable rapid updating of buy price offers down the chain from buyer to reseller to seller. Resellers and sellers respond by selectively placing offers to sell, which when met with acceptance by the other party, are transacted. Clients customize and automate their systems further by setting alarm and automated response conditions, each triggering alarms and automated transactions respectively, to increase the accuracy of and further speed the pace at which transactions occur.

### BACKGROUND

Companies involved in the purchase, sale and/or delivery of tangible commodities with physical delivery requirements, are required to recalculate their prices frequently throughout a day. Prices for these commodities are based not only on a rapidly changing Exchange quote for a futures price, but on changing costs to the businesses involved. Since costs often include transportation costs to or from a particular purchaser or seller company, the prices may likewise vary by business associate, further complicating the calculations. Hence, a company's prices for these types of commodities will not only vary frequently with changes in the Exchange quote and the company's costs, but may also vary by business associate. Much time and energy is currently expended in recalculating and communicating these price changes throughout a day and among a company's network of business associates.

For example, buyers of commodities such as corn must rapidly recalculate their prices throughout a day as the Chicago Board of Trade issues new price quotes and as the buyer's basis (i.e., the buyer's profit margin plus costs including transportation, storage and other costs) changes. If the buyer is a terminal, they must communicate those prices to their dealer associates by calling or faxing each and every one. The dealers, who act as reseller intermediaries between terminals and producers, must wait on communications from their terminal associates in order to know when to sell. These are currently both time and resource consuming processes that are prone to error.

A dealer company must likewise update its prices to its producer associates from whom they may purchase corn, to reflect the terminal price fluctuations and changes in their own basis. Since the dealer basis may depend in part on the transportation and other costs involved with buying corn from a particular producer, the dealer may need to calculate prices on a producer-specific basis. Producer companies must constantly call their dealer associates for their current prices in order to know when to sell their corn. These too are both time and resource consuming processes that are prone to error.

Some attempts have been made to address the problem of rapidly broadcasting prices to enable offers to sell in response, by transmitting them on-line on a daily basis. However, these attempts have not enabled buyers to selectively deal with known associated sellers, to tailor prices to reflect the variable costs of transportation to specific sellers, or to rapidly update their prices to reflect changes in their costs and futures prices throughout a given day. In sum, these attempts fall far short of the current system, time-consuming as it may otherwise be.

For the foregoing reasons, there is a need for a method and system for automating price discovery so as to enable the accurate and rapid real-time calculation and communication thereof in response to changes in futures prices and costs involved in the cash trade of tangible commodities. There is also a need to network buyer and seller business associates, so as to enable the rapid, accurate, secure and private generation and communication between them of associate-specific prices, offers to sell and contracts. There is furthermore a need to enable each associate in the network to customize the process to meet their particular needs and to automate their offers and other communications so as to optimize profits and to minimize market risks and the time required for transactions.

### SUMMARY

The present invention is directed to a method for automating price discovery for cash trade in a tangible agricultural commodity in real-time between a network of an at least two clients authorized to conduct business with one another that satisfies these needs.

One version comprises (1) providing one or more server computers in communication with a computer network; (2) providing input to the server from each of two or more clients comprising one or more buyers and sellers, the buyers buying the commodity from the sellers, the sellers selling the commodity to the buyers, the input comprising: if the client is a buyer, identification of an at least one authorized seller, namely a seller with whom the buyer authorizes communication and acceptance of offers to buy; if the client is a seller, identification of an at least one authorized buyer, namely a buyer with whom the seller authorizes communication and acceptance of offers to sell; (3) processing the input of each of the clients by the server, comprising: verifying that each of the authorized sellers and buyers agrees to authorize communication and acceptance of offers from their mutually-identified counterpart sellers or buyers; (4) permitting communication and acceptance of offers between authorized clients only so as to ensure confidentiality of said communications and offers; (5) providing further input to the server from each of the at least two clients, the input comprising if a client is a buyer, a buyer basis for said commodity comprising a profit margin component and a cost component; (6) providing live real-time data feed to the server from an at least one commodities exchange database comprising a set of futures prices for said commodity over a plurality of time periods; (7) upon detecting a change in the set of futures prices, real-time processing of the set of futures prices and inputs of each of said clients by the server, comprising: computing a buy price to seller offer of a buyer to each of the buyer's authorized sellers, the buy price to seller offer comprising the futures price adjusted by the buyer basis for each of the time periods; generating client-specific output from the server in real-time for each of the time periods comprising: for each buyer, the set of futures prices, the buyer's basis and the buyer's buy price to seller offers for each of the buyer's authorized sellers; for each seller, the buyer's basis and the set of buy price to seller offers for each of the seller's authorized buyers; (8) communicating the client-specific output from the server in real-time to each of the clients; (9) if a seller who receives an offer accepts the offer, inputting to the server the acceptance of the offer to the originating buyer; and, (10) if the originating buyer receiving the acceptance approves the transaction, completing the transaction; whereby, authorized buyers and sellers may automate their business practices so as to generate and receive offers and acceptances in real-time that track changes in the futures price of the commodity and in the buyer basis so as to optimize client profits and to minimize market risks and the time required to process transactions.

In another version, the method further enables clients to set alarm conditions so as to flag conditions upon which they are notified, such as good buying or selling opportunities.

In another version, the method further comprises inputs to the server of one or more alarm conditions, the one or more alarm conditions specifying conditions which, when met, prompt a notification to the client to enable the client to respond.

In another version, the method further comprises inputs to the server of one or more automated conditions, the at least one automated conditions specifying conditions which, when met, prompt a notification to the client and trigger an automated response.

In another aspect, a program storage device, readable by a machine, tangibly embodying a program of instructions executable by the machine is provided to perform one or more of the processes described above.

In another aspect, an article having a computer-usable medium has computer-readable program code embodied in the medium for performing one or more of the processes described above.

In another aspect, a computer program product is provided to perform one or more of the processes described above.

These and other features and aspects of the method and system will become better understood with reference to the following description, accompanying drawings, and appended claims.

Several objects and advantages of the present invention are:

a) means by which to automate the practice of commodities exchange so as to enable real time and accurate updating of current price quotes, margins and bid and sale offers, thereby enabling real-time communications between established business partners so that they make purchase or sale decisions in reaction to current price changes to minimize risks and optimize profits;

b) means by which to facilitate the practice of cash quote and commodities exchange by providing a new system of clients in real-time networked communication with one another and the futures price quote exchange, so as to enable users to practice the business of purchase and sale in tangible commodities in a more time-efficient manner, allowing them to enter and change offers and cost facts rapidly; and,

c) means by which to enable direct transactions between buyers and sellers in commodities practice generally involving a reseller between the two, the on-line networked system of the present invention enabling rapid communications between a buyer and many sellers.

Whereby a method for automating price discovery for cash trade in a tangible agricultural commodity in real-time between a network of two or more clients authorized to conduct business with one another is provided enabling authorized buyers, resellers and sellers to automate their business practices so as to generate and receive offers and acceptances in real-time that track changes in the futures price of the commodity and in the buyer and reseller basis so as to optimize client profits and to minimize market risks and the time required to process transactions.

The reader is advised that this summary is not meant to be exhaustive. Further features, aspects, and advantages of the present invention will become better understood with reference to the following description, accompanying drawings and appended claims.

### BRIEF DESCRIPTION OF DRAWINGS

For a better understanding of the present invention, reference may be made to the accompanying drawings, in which:

FIG. 1, shows a flow chart representation of one version of the method of the present invention;

FIG. 2, shows a detail of the step 100 of FIG. 1, detailing some of the client inputs;

FIG. 3, shows a generalized depiction of one version of the system of the present invention;

FIG. 4, shows a version of a Web page for a seller/producer client of the system;

FIG. 5, shows a version of a Web page for a reseller client of the system;

FIG. 6, shows a version of a link to one of the reseller's seller client's information pages from the reseller page presented in FIG. 5;

FIG. 7, shows a version of a link to one of the reseller's buyer client's information pages from the reseller page presented in FIG. 5;

FIG. 8, shows a diagram depicting the supported multi-way and bi-directional client relationships; and,

FIG. 9, shows an aspect of the general system of the present invention.

### DESCRIPTION

Referring now specifically to the figures, in which identical or similar parts are designated by the same reference numerals throughout, a detailed description of the present invention is given. It should be understood that the following detailed description relates to the best presently known embodiment of the invention. However, the present invention can assume numerous other embodiments, as will become apparent to those skilled in the art, without departing from the appended claims.

It should also be understood that, while the methods disclosed herein may be described and shown with reference to particular steps performed in a particular order, these steps may be combined, sub-divided, or re-ordered to form an equivalent method without departing from the teachings of the present invention. Accordingly, unless specifically indicated herein, the order and grouping of the steps is not a limitation of the present invention.

Definitions

Basis. A basis comprises a profit margin component plus a cost component. A buy price offer is adjusted by the basis amount to reflect the profit margin and cost components relative to a particular transaction. A buyer basis' cost component may include factors such as the costs of storage, transportation, barges, trucks, facilities, and the like. A reseller basis' cost component may include factors such as the costs of storage, transportation, buildings, and the like. Alternatively, the seller-specific freight costs may be considered separately to generate price offers specific to sellers based on the seller's distance from the reseller.

Buy price to reseller. Buy price to reseller is the price a buyer offers to pay a reseller for a commodity. It is calculated as the futures price adjusted by the buyer basis.

Buy price to seller. Buy price to seller is the price a reseller offers to pay a seller for a commodity when the commodity is delivered by the seller to the reseller. It is calculated as the buy price to reseller adjusted by the reseller basis. Alternatively, if a non-reseller buyer offers a buy price to seller, the price is calculated as the futures price adjusted by the buyer's basis.

Buy price to seller picked up. Buy price to seller picked up is the buy price to seller adjusted by a cost of freight reflecting the cost to the reseller to transport the commodity from the site of a seller to the site of the reseller.

Buyer. A buyer is a type of client that buys a commodity from a reseller or a sellerr for resale to another buyer either as the raw commodity or the processed commodity.

Client. A client is a user of a version of the present invention. A client may be a buyer, reseller, seller or other type of dealer in a commodity such as a financial institution, business manager, etc. An authorized client is a client authorized to communicate and place offers with another client with which it has a previous business relationship. For example, authorized clients of a particular buyer 1 may include reseller x, reseller y and reseller z. Likewise, authorized clients of reseller x may include buyer 1 and buyer 2 as well as seller a, seller b, seller c, seller d and seller e. Communications and offers between authorized clients remains confidential between them.

Commodity. As referenced in the present invention, a commodity is a tangible good that is traded for cash and has physical delivery requirements. Examples of such commodities are corn, soybeans, wheat, cattle, hogs, poultry, raw milk, butter, cheese, cocoa, sugar, coffee or other types.

Exchange. An exchange is a Board of Trade that quotes a futures price for commodities, i.e. an Exchange quote. An example is the Chicago Board of Trade (CBOT) that quotes the cash price for corn, soybeans and wheat among other commodities.

Futures price. A futures price is a price set by an Exchange for a commodity at a given time period in the future. Also known as an Exchange quote.

Reseller. A reseller of the commodity. An example is a grain dealer that buys a grain such as corn from a producer then stores it for later resale to a terminal or other party.

Seller. A seller of a commodity. Generally this is the producer of the commodity such as a farm that produces the commodity and sells it to a reseller.

Detailed Description—Method

The following description of one version of the method of the present invention uses the commodity corn by way of example. The reader is reminded, however, that the method may be applied in the context of other types of commodities as well such as other crops like soy beans or wheat, livestock such as cattle or hogs, dairy commodities such as cheese or butter and the like.

The method is a method for automating price discovery for cash trade in a tangible agricultural commodity in real-time between a network of two or more clients authorized to conduct business with one another, whereby, clients such as authorized buyers, resellers and sellers may automate their business practices so as to generate and receive offers and acceptances in real-time that track changes in the futures price of the commodity and in the buyer and reseller basis so as to optimize client profits and to minimize market risks and the time required to process transactions.

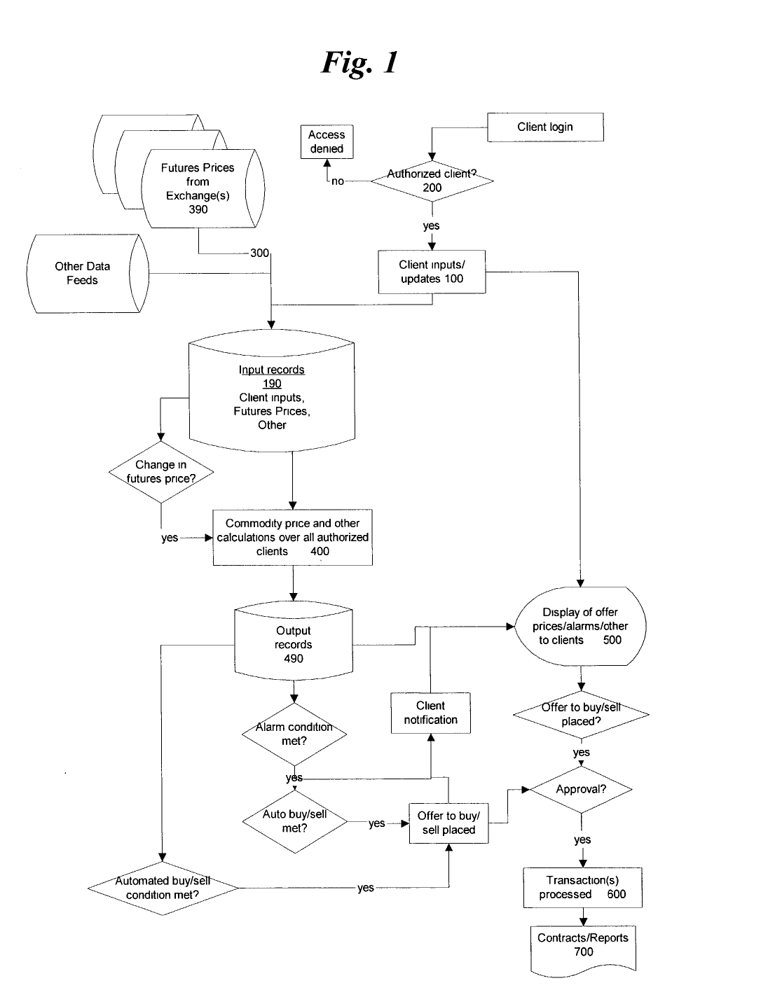

One or more servers are provided in communication with a computer network. Referring to FIG. 1, the method generally comprises the steps of (1) providing client inputs to a server computer that are stored in an inputs database 100; (2) verifying authorized clients to permit communication and offers between authorized clients only 200; (3) providing live real-time data feed to the server from an at least one commodities exchange database 390 comprising a set of futures prices for said commodity over a plurality of time periods 300; (4) calculating commodity price and other values such as alarm and automated buy/sell conditions over all authorized clients 400; (5) communicating and displaying the calculated price and other values to specific authorized clients 500; (6) processing transactions 600; and (7) generating contracts and reports 700.

As defined above, clients are of various types including buyers, resellers or sellers of the commodities. There may additionally be other types of clients such as financial institutions and others.

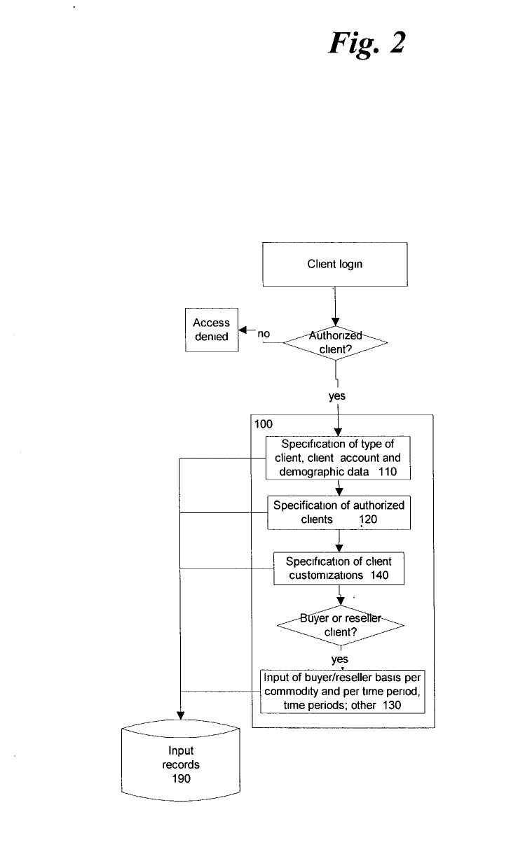

Providing client inputs to a server computer that are stored in an inputs database 100. Referring to FIG. 2, when clients first login, they input information 100 that is then stored as input records 190 in a server database 890. Upon subsequent logins, registered clients may update their inputs at anytime.

Clients enter information regarding their account and demographic information 110. Questionnaires prompt clients to fill in identity information such as their names and contact information as well as demographic information of a type based on the client's type, i.e. buyer, reseller, seller or other type of client. A seller who produces commodities for sale, may be prompted to indicate the size of its operation, how many acres it farms, whether it owns or rents land, amounts of commodities it produces, types of cash or futures contracts it uses to market the commodities it produces, types of equipment and services it uses, etc. A reseller may likewise be prompted for similar further including its business identification numbers and licenses, what commodities it resells, types of transportation is utilizes, whether and what types of transport vehicles it owns or rents, and the names of brokerage firms where they do business. A buyer is prompted to supply information regarding its contact information and what kinds of commodities it buys and/or processes.

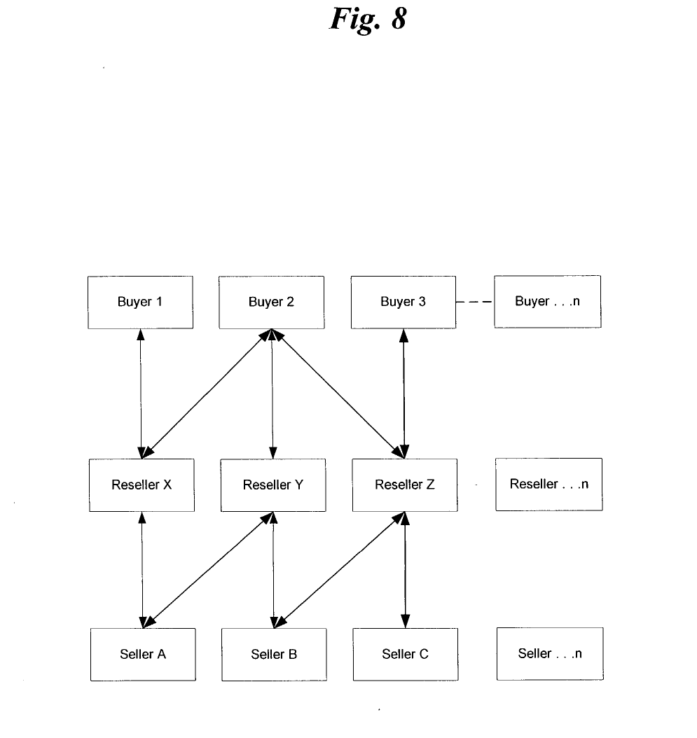

Each client is also asked to supply the names of one or more other clients with whom they do business, or authorized clients 120. An authorized client is a client authorized to communicate and place offers with another client with which it has a previous business relationship. The resulting method and system supports multi-way relationships that are bidirectional (see FIG. 8). For example, authorized clients of a particular buyer #2 may include reseller x, reseller y and reseller z. Likewise, authorized clients of reseller x may include buyer #2 and buyer #3 as well as seller b and seller c. Additionally, seller a may have authorized relationships with resellers 1, 2, and 3. Communications and offers between authorized clients remains confidential between them. In the above example, the fact that reseller x and seller d constitute two clients authorized to communicate confidentially with one another, does not mean that the communication between reseller x and seller e will be accessible to seller d.

Other inputs provided by clients include, if a client is a buyer or reseller, a buyer or reseller basis and other information 130. For example, a buyer may input the definition of commodity being bought and sold and the time periods for which futures prices for the commodity are generated. The basis is generally calculated by adding a profit margin component and a cost component and used in calculating a buy price offer. A buy price offer is adjusted by the basis amount to reflect the profit margin and cost components relative to a particular transaction. For example, a buyer basis' cost component may include factors such as the costs of storage, transportation, barges, trucks, facilities, and the like. A reseller basis' cost component may include factors such as the costs of storage, transportation, buildings, and the like. Alternatively, the seller-specific freight costs may be considered separately to generate price offers specific to sellers based on the seller's distance from the reseller. Regardless, clients may input basis values that vary with commodity, with seller or reseller, with time period and the like. A client may update their basis values as and when the need arises. During the commodity price calculation step 400, these basis values are retrieved for a given client from the server database 890 in order to calculate buy offer prices.

As another example, a buyer or reseller may manually enter margin differentials to adjust their basis either globally or for specific authorized client partners. The ability to adjust the basis via a margin differential factor, enables a buyer/reseller client to bid competitively for a particular seller's commodities or to accomplish other strategies. Table 1 below shows a row for input of margin differentials.

Clients may further specify customizations 140. For example, they may opt to set alarm conditions that alert them to when a certain level of buy price offer is placed, or which offer from among multiple buyers and over multiple time periods is the best price at which to sell. If a client opts to set alarm conditions, the conditions are tested for during the price calculation step 400 as prices are being calculated for distribution to specific clients. Likewise, a client may opt to define automated buy or sell conditions. For example, a reseller client who offers to sell a buyer 100,000 bushels of corn, may opt to specify a condition that enable it to automatically accept offers to sell from any of its authorized clients until the amount of 100,000 bushels is purchased. Or similarly, a condition may be set to specify that a seller may automatically place offers to sell in response to reseller buy price offers greater than a certain dollar amount and until a certain amount of the seller's corn is sold.

The client server database 890 accumulates and stores input records from the clients for use in the authorization 200 and calculation 400 steps below.

Verifying authorized client status to permit communication and offers between authorized clients only 200. Clients input a list of authorized clients with whom they wish to do business 120. However, in order to establish that one or more parties in an authorized group of clients approves of the relationship, the client is unable to communicate or exchange offers with another client they name until authorization is confirmed. In the authorization step, the named client is asked to verify the relationship so as to assure that there is mutual agreement to communicate and exchange offers between the. Once verified, the authorized clients is able to do so. For example, buyer 1 and reseller x may be an authorized pair of clients. This means that buyer 1 may communicate buyer price to reseller offers to reseller x and reseller x may respond with an offer to sell to buyer 1 at one or more of the price offers. Likewise, reseller x may be authorized to communicate buyer price to seller offers to seller a. Because reseller x has an established relationship to seller a, reseller x is able to enter into the server database 890, seller a specific basis values to reflect a cost component particular to that seller or further enter freight costs particular to the seller so as to enable it to also generate buyer price to seller pick up offers. Being able to identify authorized client groups, enables members of the group to input data specific to each other and to enable client-specific calculations in step 400.

Providing live real-time data feed to the server from an at least one commodities exchange database 390 comprising a set of futures prices for said commodity over a plurality of time periods 300. Live real-time data feed to the server from one or more commodities exchange databases 390 comprising a set of futures prices for said commodity over multiple time periods, is provided to the system. Buyer price offers are based on the futures price, and reseller price offers are based on buyer price offers. Hence, changes in the futures prices cause all price offers in the chain to change. Having real-time data feed, enables the updating of price offers and the like 400 throughout a day providing clients with up to the minute information regarding current prices that they can act upon quickly.

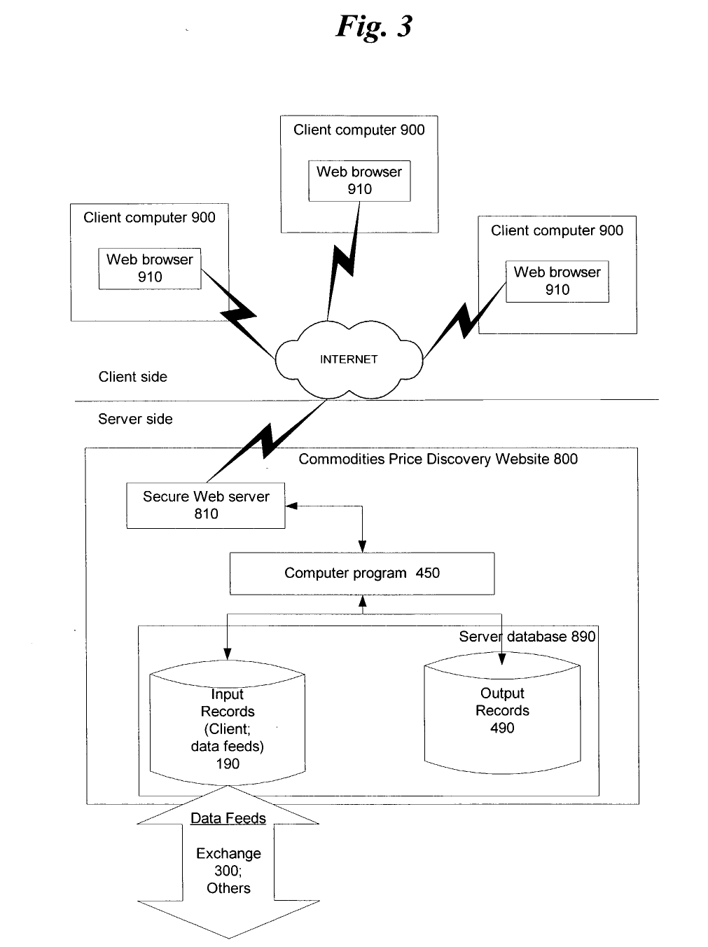

The futures prices data and client inputs (see step 100) are stored as input records 190 in the server database 890 along with data from other data feeds (e.g. streaming news and/or board quotes, weather reports, DTN, National grain & feed association news). The system allows the user to configure live data feeds. Data may be retrieved for use in further calculations or displayed as is at a client's computer 900 (see FIG. 3).

Calculating commodity price and other values such as alarm and automated buy/sell conditions over all authorized clients 400. Upon detecting a change in the set of futures prices, real-time processing of the set of futures prices and client specific inputs is conducted by the server. Each tick of the exchange triggers calculations that propagate through the database to generate new updated pricing and other information that is stored as output records 490 in a server database 890. Since futures prices are generated by commodity and by time period, subsequent calculations are made over all time periods. Calculations are performed by means of one or more computer programs 450 (see FIG. 3).

For example, the buy price to reseller offer of a buyer, such as a terminal buying corn, to each of the buyer's authorized resellers, such as corn grain dealers, is calculated by taking the futures price and adjusting it by the buyer basis for each the time periods. Since these calculations are generated in real-time in response to changes in the futures prices throughout the day, a buyer can generate buy offers for all of its authorized resellers and over all time periods quickly and as often as required to reflect the futures price changes. Being able to do so quickly and accurately and to communicate the offers immediately (see step 500), saves the buyer a great deal of time and money and enables a buyer to minimize its risks in trades.

Likewise, a buy price to seller offer of a reseller is calculated and communicated to each of the reseller's authorized sellers. It is calculated by taking the buy price to reseller and adjusting it by the reseller basis for each time period. Since the reseller's buy price offer is based on that of the buyer, which in turn is based on the futures price, it too will vary throughout the day. Likewise, it may vary as the costs included in the cost component of a reseller's basis varies over time. The ability to update those basis values (see step 130).

A reseller may also generate a buy price to seller pick up which is the buy price to seller adjusted for freight costs to particular seller. By being able to adjust rapidly changing buy price offers by freight costs input by the reseller for each of its authorized sellers, enables the generation of current price offers for multiple time periods that not only tracks changes in futures prices but freight costs as well.

As mentioned above under the specification of customizations step 140, clients may set alarm conditions and automated transactions conditions. If they have done so, the price calculations are further monitored to determine if the predefined condition(s) are met. If, for example, the reseller/grain dealer can set one to many alarm points for a specific commodity and period on the futures price quotes and buyer/terminal buy prices to reseller. When the alarm criteria have been met the reseller/grain dealer is notified (as in step 500) and can then respond by making an offer to buy or sell the commodity. Likewise, a reseller/grain dealer may set an automated transaction condition such as a quantity limit. This would enable the reseller/grain dealer to automatically accept offers to sell the commodity until the amount purchased reaches the limit set.

Similarly, a seller/producer may set one or more alarms for specific commodities and time periods. The seller/producer is notified when the alarm conditions are met and is then able to act by tendering one or more offers to sell. The producer may also set automated transaction conditions to automate offers to sell, for example, in response to buy price to seller offers above a certain price.

Being able to set alarm and automated transaction conditions, further streamlines the process of purchase and sale of commodities to enable the clients involved and enables participants to make more informed decisions that enable minimization of risk and maximization of profits.

The server database 890 may be a distributed or other type of database. Other records in addition to the input records 190 and output records 490 may be stored and used for various purposes. Certain of the output records 490 may comprise all transactions posted within a 24 hour period for use in reporting a day's activities. Certain other of the output records 490 may contain historical transactional data for use for research, accounting and other purposes.

Communicating and displaying the calculated price and other values to specific authorized clients 500. An example of the above calculations and how they might be communicated and displayed to a client is represented in Table 1 below. The values indicated in a table such as this displayed at the site of a client, would be updating frequently throughout a day as futures prices change. Further description of the types of displays that may be presented to clients is given in the system description section below.

The example presented in Table 1 represents trade in corn as the commodity. The buyer would be a terminal, the reseller a grain dealer and the seller the farmer producer who grows the corn. The exchange is the Chicago Board of Trade (CBOT) and it generates a futures price quote by month. The terminal then set the delivery periods and CBOT quote months for each delivery period.

The terminal bids are in tenths so −22.5 equates to −22 and a half cents. Table 1 below is an example of what the terminal generates based on the CBOT. The first row is the CBOT month (expressed in code to indicate commodity type, month and year). The second row is the CBOT futures price quote for the CBOT month. The third row are the buyer/terminal's delivery periods. The fourth row is the buyer/terminal basis to the reseller/grain dealer. The fifth row is calculated by taking the CBOT futures price quote for the CBOT month plus or minus the buyer/terminal's basis. Inputs of futures prices and buyer/terminal basis values used to calculate the buy price to reseller (i.e. the buyer/terminal's price offer to its authorized reseller/grain dealer).

Once the buyer price to reseller values are generated, further calculations adjusting that price by the reseller/grain dealer's basis, generates values for the reseller/grain dealer buy price offers to seller/producers (row 5). Both the reseller basis and buy price to seller are displayed to authorized sellers of the reseller. Finally, a reseller's buy price to seller pick up is generated by adjusting the buy price to seller by the cost of freight to transport the corn from that seller/producer to the reseller/grain dealer. The seller then can view both prices (with and without freight charge adjustment) and decide whether and which offer to respond to.

TABLE 1

| | | | | | | | | |
|---|---|---|---|---|---|---|---|---|
| CBOT | CZ00 | CZ00 | CZ00 | CH01 | CH01 | CH01 | CK01 | CK01 |
| Month | | | | | | | | |
| CBOT | 2160 | 2160 | 2160 | 2272 | | 2276 | | 2350 |
| futures | | | | | | | | |
| price quote | | | | | | | | |
| Buyer | Nov0 | LH.Nov0 | FH | Jan1 | Feb1 | Mar1 | Apr1 | May1 |
| delivery | | | Dec0 | | | | | |
| periods | | | | | | | | |
| Buyer | −19 | −15 | −10 | −22.5 | −21.5 | −9.5 | −15.5 | −12.5 |
| basis | | | | | | | | |
| Buyer | $1.97 | $2.01 | $2.06 | $2.0475 | $2.0625 | $2.0575 | $2.195 | $2.225 |
| price to | | | | | | | | |
| reseller | | | | | | | | |
| Reseller | −2 | −2 | −2 | −2 | −3 | −3 | −2 | −3 |
| basis | | | | | | | | |
| Margin | 0 | 0 | 0 | 0 | 0 | 0 | 0 | 0 |
| differential | | | | | | | | |
| Buy price | $1.95 | $1.99 | $2.04 | $2.0275 | $2.0325 | $2.0275 | $2.175 | $2.195 |
| to seller | | | | | | | | |
| Freight | −1 | −2 | −2 | −1 | −2 | −2 | −2 | −2 |
| cost | | | | | | | | |
| Buy price | $1.94 | $1.97 | $2.02 | $2.0175 | $2.0125 | $2.0075 | $2.155 | $2.175 |
| to seller | | | | | | | | |
| picked up | | | | | | | | |

As mentioned above under the specification of customizations step 140, clients may set alarm conditions and automated transactions conditions. If they have done so, the alarms and status of automated transactions will be indicated on their displays.

Processing transactions 600. Clients receiving buy offers may respond to those offers at any time by placing an offer to sell. The client who placed the buy price offer (i.e. a buyer to a reseller, or a reseller to a seller), responds by accepting or not accepting the offer. Both the offer to sell and acceptance may occur rapidly as both clients are operating in real time. Because only clients authorized to communicate and exchange offers are allowed to interact, offers and acceptances of this sort are equivalent to verbal agreements. Both parties receive confirmation of the terms of the particular offer and acceptance and written contracts may be generated immediately.

Generating contracts and reports 700. The method further enables client users to print reports and to generate contracts. The server database 890 may be accessed by a client user to generate customized reports according to the user's needs. Thus clients are able to document their activities and to customize the way their information is presented. As mentioned, links to other data feeds may be provided and these sources of information may be used to further augment the research capabilities of the client user.

Detailed Description—System

The system of the present invention provides means for automating price discovery for cash trade in a tangible agricultural commodity in real-time between a network of an at least three clients authorized to conduct business with one another (FIG. 3). A general-purpose computer, its component devices, and software, provide means for implementing the method steps described above.

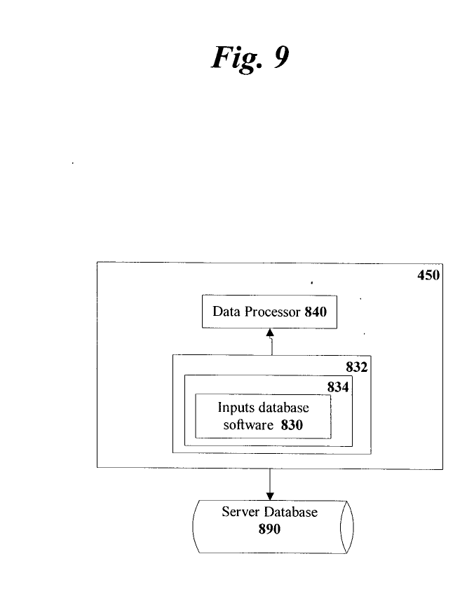

Referring to FIG. 9, in a computer program module 450, the server database 890 is created by inputting, pre-processing, and further manipulating, the input records 190 to the system. The server database software 830 resides on a program storage device 832 having a computer usable medium 834 for storing the program code. The program storage device 832 may be of a conventional variety, such as a conventional disk or memory device. The server database software 830 may be created using general-purpose application development tools such as programming languages, graphical design tools, and commercially available reusable software components. A general database engine may be used to manage input records data storage and retrieval. The processor 840 is part of a general-purpose computer system. Any general-purpose computer may be used, provided that the processing power and server capabilities are sufficient to achieve the desired speed of computation for the amount of inputs data being processed by the system.

It should be noted that, though the server database module 450 may be a distributed database or of some other type.

Once the outputs records 490 are stored in the server database 890, they may be used in documenting, researching and accounting activities according to the needs of the client. The system accommodates post-processing of the output records 490, allowing delivery in various formats and through various electronic media. The system can generate output in the form of further analyses and presentation as graphs, spreadsheets, maps, HTML documents, or other formats. Queries may be formulated to a user's specifications in order to create customized output to use in making management and/or procurement decisions. The output can be delivered electronically through a variety of channels, including facsimile, e-mail, local area networks (LANs), wide area networks (WANs) and the worldwide web. It can also, of course, be provided in hard copy.

The following description of one version of the on-line system of the present invention uses the commodity corn by way of example. The reader is reminded, however, that the system may be used by clients dealing in other types of commodities as well such as other crops like soy beans or wheat, livestock such as cattle or hogs, dairy commodities such as raw milk or butter and the like.

Referring to FIG. 3, a commodities price discovery Web site 800 is provided as an Internet based commodities bid and offer bulletin board service. The system allows client users to post price bids and offers, keep track of their personal accounts, set alarm condition criteria, monitor the board and interrogate historical trade information to track any given commodities market. In keeping with the open outcry criteria, the online client users will be able to bid, offer, and counter as part of the traditional negotiation process and as described in the method description section above. Also in an effort to keep optimum liquidity, any In-play commodities can be countered on by multiple users simultaneously. The commodities price discovery Web site 800 becomes the intermediary in facilitating these online transactions by stepping in between the trades to guarantee a successful transaction. Title of all commodities purchased or sold on the website pass through the company running the Web site 800 to their final titleholder with a commission being held to act as facilitator. Thus, in one version of the present invention, all account holders will make payable to and will receive payment from the Web site company.

The on-line system of the present invention can be configured to be a public or private network. As depicted in FIG. 3, the Website 800 is served up over the Internet via its secure Web server 810. Various data feeds input to the system, including the live data feed 300 of futures prices from an Exchange, as well as other types of data feeds such as weather, news, market and other informational feeds. Likewise, client users provide data feeds to the Web site 800 as they input client account, authorized client partner, basis, margin differentials and other information (see FIG. 2, step 100). In addition, client users communicate with their authorized partner clients via the Web site 800 as they exchange buy offers, acceptances and other communications in order to enable various commodity purchase and sale transactions to occur between them.

Enabling the inputs from a variety of data feed providers allows the client users to tailor their individual user Website. For example, a user client may desire to, in addition to the commodities prices, have weather or news reports presented at their Web browser 910. These data feeds can dictate the minimal hardware requirements. Though, generally, only minimal hardware is required to access the commodities price discovery Web site 800. Any client with a personal computer 900, access to the Internet and a login account with the company, can access the Web site 800. Private network configurations are also possible and allow enhanced security and privacy features and enable more rapid communications between clients and the Web site 800.

Example of Using the Method and System of the Present Invention.

As described above, price and other information as well as alarm and other notifications are displayed 500 to the client. The client's Web browser 910 enables viewing of a Web page customized for use by a particular type of client and for the individual client user. The type of client user is one of the client inputs 100 mentioned above. For example a client user may be a buyer, reseller or seller as we have discussed previously. Or a client user may fall into some other category such as a financial institution. Whatever type of client, the client may further customize its Web page according to his needs.

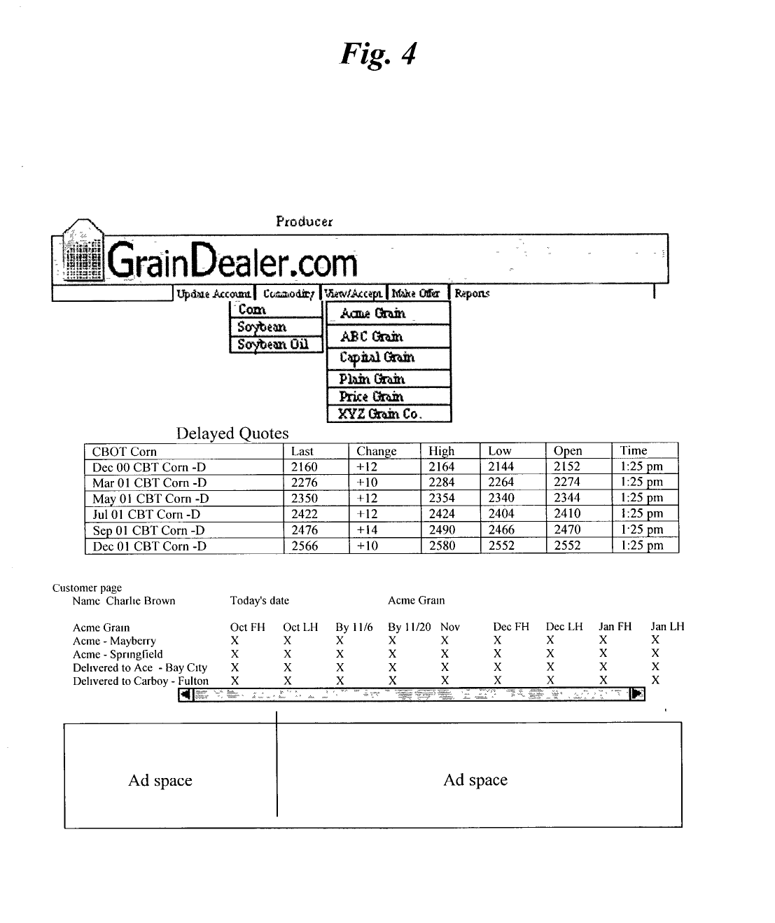

In this example, the company is called GrainDealer.com and it is running a commodities price discovery Web site 800 by the same name, specializing in price discovery for corn and soybean commodities. A seller/producer Web page may look something like what is presented in FIG. 4. The seller/producer's name in this example is Charlie Brown, and the commodities he may access information for via a drop down menu are corn, soybeans and soybean oil. Data for six authorized reseller clients, in this case grain dealers, are accessible to the seller/producer, Acme Grain, Capital Grain, Plain Grain, Price Grain and XYZ Grain.

Corn is the currently selected commodity and Acme Grain is the currently selected reseller/dealer, and so delayed quotes (futures prices) on corn and information specific to Acme grain are displayed to the seller/producer for the various time periods. The Acme grain buy price to seller bid offers for various time periods are displayed for review by the seller/producer. Note that prices with and without delivery to certain Acme facilities are displayed. Buttons along the top enable the seller/producer to place an offer to sell and to view price offers form other of its authorized reseller/dealers as well as for other commodities.

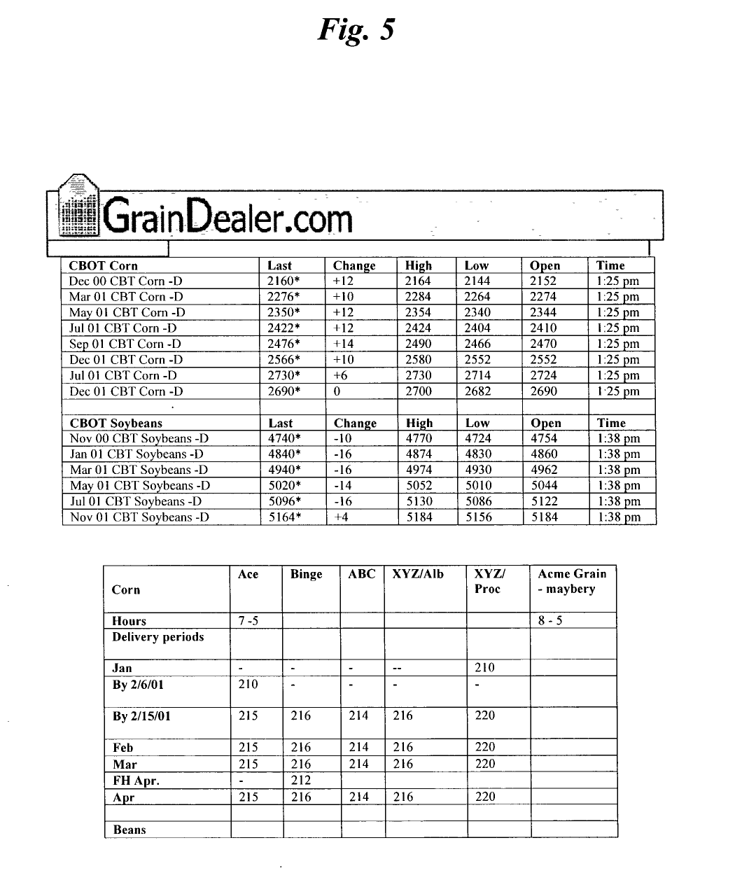

FIG. 5 shows an example of a reseller/grain dealer Web page, for Acme Grain. The top portion of the page displays the commodity futures prices for various time periods and for two commodities, corn and soybeans. These numbers may flash when futures prices change throughout the day. The bottom portion displays information from the reseller/grain dealer's authorized buyer/terminal clients, Agri, Bunge, CGB, ADM, etc. Buyer/terminal buy price offers are listed by time period.

The reseller/dealer will have a menu option to show the best buyer/terminal price to reseller bid offer per delivery period. The best bid will be highlighted or otherwise flagged to identify it to the dealer. The dealer may act on the bid and place an offer to sell.

As mentioned in the method description, clients set alarms. A reseller/dealer such as Acme Grain, benefits greatly from this feature as the prices are varying rapidly throughout the day and by buyer clients. A client reseller/dealer may set alarms for best price from all buyer/terminals, a specific buyer/terminal or board of trade futures price quote. The client may display all the alarms currently set. If the client user enters a commodity, high price and delivery period and the board of trade futures price quote is equal to or higher than the set price, a dialog box is generated displaying the alarm detail. If the client user enters a commodity, low price and delivery period and the board of trade futures price quote is equal to or lower than the set price, a dialog box is generated displaying the alarm detail. If the user enters a commodity, high price, low price and delivery period, a range has been set. If the board of trade futures price quote is equal to or outside the range specified, a dialog box is generated to display the alarm detail. The user is allowed to select an alarm then click on the delete button to remove the alarm from the list.

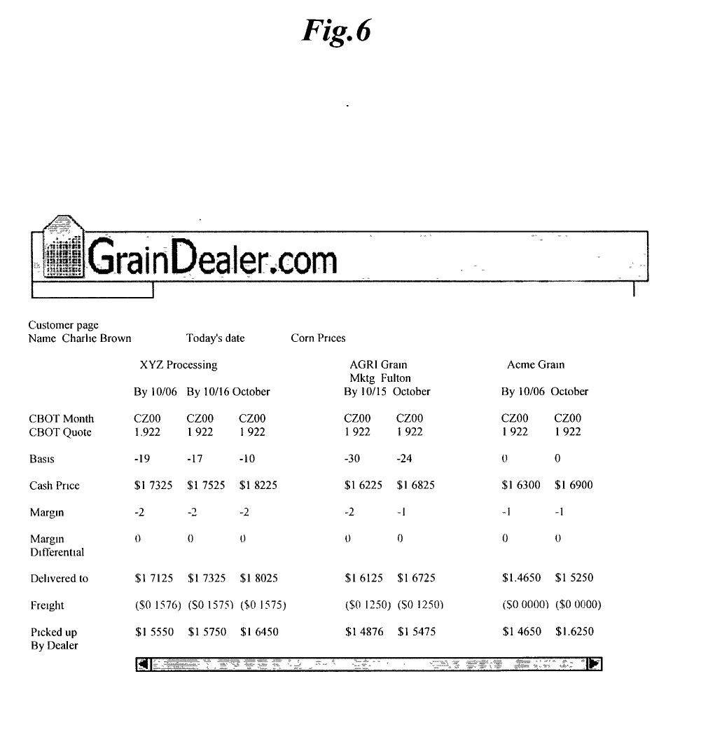

A reseller/dealer client may also access from its Web pages, pages for its various authorized seller/producer clients to track their respective offers to sell and transactions. An example of such a page is given in FIG. 6. The selected seller/producer is Charlie Brown. The grain dealer/reseller and buyer/terminal are sorted by delivery months and the information is displayed. The reseller basis (margin), margin differential and freight fields can be modified. The terminal, or buyer, basis can only be modified for the current grain dealer. In this example the current grain dealer is Acme Grain so, the only fields that can be modified by Acme Grains are the reseller basis, margin, margin differential and freight and all the buyer/terminals margin, margin differential and freight for Charlie Brown. Any change to the modifiable fields will prompt the re-calculation and display of the updated information.

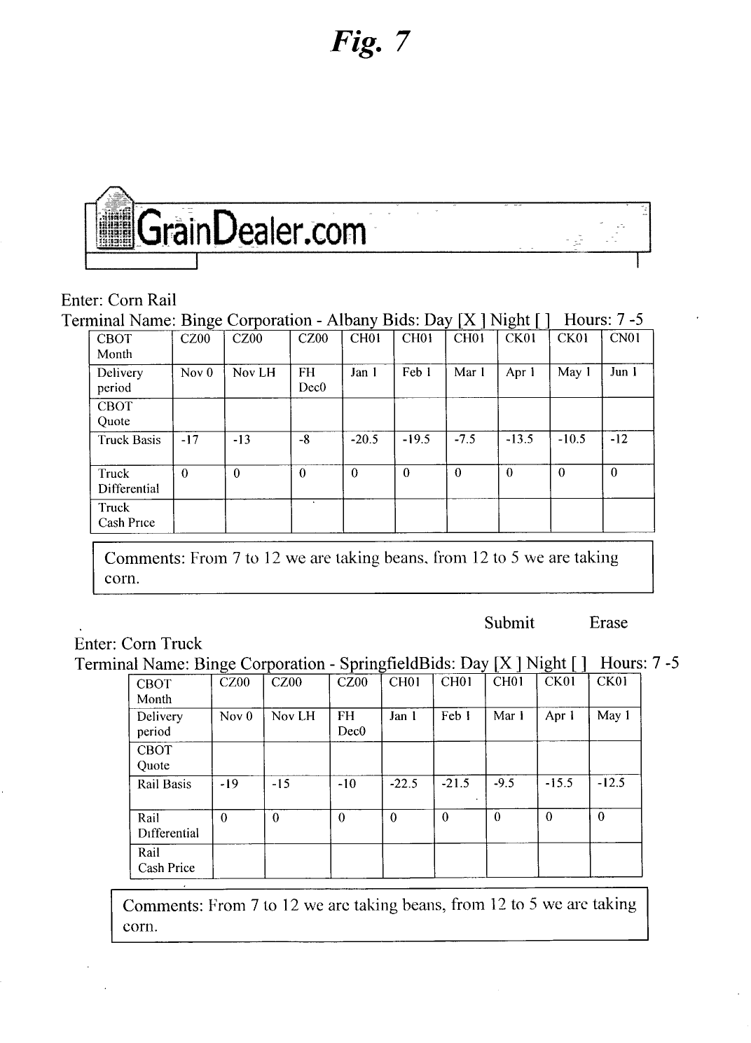

Likewise a reseller/dealer may access a page for one of its buyer/terminal authorized clients. A web page is created that contains tables based on that buyer/terminal's commodities and delivery methods (Barge, Truck, Rail). If the buyer/terminal does not have an account with the company, in this example GrainDealer.com, the reseller/grain dealer can enter the terminal buy price to reseller bids, but those bids are only viewable by the grain dealer that entered the data. If a terminal has an account, the terminal will enter its buy price to reseller bids for all grain dealers. The grain dealers will not be able to modify the bids in this case, only display them. In FIG. 7, the buyer/terminal Binge Corporation is used by way of example. Binge corporation does not have a grain dealer account so Acme grain (i.e. the reseller/grain dealer) selects Binge Corporation from the customer list. Acme grain enters the delivery periods and the Chicago Board of Trade (CBOT) month for that delivery period, truck basis, truck differential and comments for each commodity and delivery method. There is a submit button for each table. The client user can enter all the commodities at once then submit each one. Or if a commodity changes throughout the day the grain dealer can modify the commodity that changed.

In the case where the buyer/terminal does have an account, the same tables are displayed but populated by the terminal, there is no submit or erase button on the grain dealer's terminal page in that case.

The above are just a few examples of the types of Web pages client users may view using their Web browsers 910. Pages may be customized for other users and for other purposes. Pages to view offers may be displayed so that a client user, such as a seller/producer may view all offers. On such a page offers may be placed, reviewed or cancelled. A producer may click a reject button and the offer is rejected and the particular reseller client informed of the rejection.

When a client user clicks on make offers buttons, the client user type is identified (i.e. buyer, reseller, seller). If the user is a seller/producer the database returns all the producer's authorized reseller/grain dealers. The grain dealer buttons may be radio buttons. The offer is sent to the appropriate grain dealer and the producer selects view offers to get the confirmation information. If the client user clicks on send, the information is displayed and the user is asked to confirm the order. Once the order has been confirmed the client user clicks a send button and a transaction number is generated, displayed and logged.

Offers may be placed in different ways. For example, for a flat rate offer the seller/producer enters a dollar value in a value field. The seller/producer enters a price value, e.g. −2, in the value field and codes a time period (e.g. CZ00) in the futures month field and a basis or hedge to arrive (HTA) offer. The producer then clicks on a market to verify that nothing is entered in the value and futures fields. The producer may verify the futures month by clicking on HTA or Basis. If the futures month is incorrect, an error message is displayed along with the correct futures months for that commodity, allowing the producer to select one of the futures months. If flat price or market is selected, the fact that no futures month is entered is verified. When the producer clicks on Send, the offer is reconfirmed. If the user clicks OK, the offer is submitted to the database and a transaction number is displayed. The status of this offer is then pending.

If the user type is a grain dealer. The database returns all the grain dealers terminals. The form has two buttons “send” and “cancel”. The user enters the offer and clicks the send button. The offer is sent to the appropriate terminals. The user clicks on cancel the form is cleared and nothing is sent.

If the reseller grain dealer clicks on multiple terminals the buyer/terminal must be informed that the bid offer is competitive. This status is indicated in the status field as “Competitive offer.” In the event that a competitive cash offer is sent to multiple terminals 4,6,8,10. One of the terminals, e.g. Terminal 6, may then accept the offer and send back the confirmation information. The other terminals are informed that the order has been filled, status is “sold.” If market price is checked, then only one terminal can be selected. The rest of the transaction occurs similarly as with the seller/producer.

Reports may be generated 700. When the client user clicks on the transaction report menu option, the user type is identified. The report page has two options default and date range which may be selected. If the user doesn't enter a date range the default is used. In default mode, the database will return all the transactions the user had for the day. If a date range is entered, the database will return all transactions from the start date to the end date. If the reseller/grain dealer or buyer/terminal has been defined as the parent, the reports will include the parent and all the children. The report will contain each offer followed by the confirmation if applicable. The report generated is web based and printable.

### ADVANTAGES OF THE INVENTION

The previously described versions of the present invention have many advantages, including:

d) means by which to automate the practice of tangible commodities exchange so as to enable real time and accurate updating of current price quotes, margins and bid and sale offers, thereby enabling real-time communications between established business partners so that they make purchase or sale decisions in reaction to current price changes to minimize risks and optimize profits;

e) means by which to facilitate the practice of cash quote and commodities exchange by providing a new system of clients in real-time networked communication with one another and the futures price quote exchange, so as to enable users to practice the business of purchase and sale in tangible commodities in a more time-efficient manner, allowing them to enter and change offers and cost facts rapidly; and,

f) means by which to enable direct transactions between buyers and sellers in commodities practice generally involving a reseller between the two, the on-line networked system of the present invention enabling rapid communications between a buyer and many sellers.

Whereby a method for automating price discovery for cash trade in a tangible agricultural commodity in real-time between a network of two or more clients authorized to conduct business with one another is provided enabling authorized buyers, resellers and sellers to automate their business practices so as to generate and receive offers and acceptances in real-time that track changes in the futures price of the commodity and in the buyer and reseller basis so as to optimize client profits and to minimize market risks and the time required to process transactions.

The present invention does not require the incorporation of all of the advantageous features and advantages into every embodiment thereof.

Closing

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method for automating price discovery for cash trade in a tangible agricultural commodity in real-time between a network of an at least three clients authorized to conduct business with one another, the method comprising:
providing an at least one server computer in communication with a computer network;
providing input to the server from each of the at least three clients comprising an at least one buyer, an at least one reseller and an at least one seller, the buyer buying the commodity from the reseller, the reseller buying the commodity from the seller and selling the commodity to the buyer, and the seller selling the commodity to the reseller, the input comprising:
if the client is a buyer, identification of an at least one authorized reseller, namely a reseller with whom the buyer authorizes communication and acceptance of offers to buy;
if the client is a reseller, identification of an at least one authorized seller, namely a seller with whom the reseller authorizes communication and acceptance of offers to buy; and identification of an at least one authorized buyer, namely a buyer with whom the reseller authorizes communication and acceptance of offers to sell;
if the client is a seller, identification of an at least one authorized reseller, namely a reseller with whom the seller authorizes communication and acceptance of offers to sell;
processing the input of each of said clients by the server, comprising:
verifying that each of the authorized sellers, resellers and buyers agrees to authorize communication and acceptance of offers from their mutually-identified counterpart sellers, resellers or buyers;
restricting communication and acceptance of offers to authorized clients only so as to ensure confidentiality of said communications and offers;
providing further inputs to the server from each of the at least three clients, the inputs comprising:
if a client is a buyer, a buyer basis for said commodity comprising a profit margin component and a cost component;
if a client is a reseller, a reseller basis for said commodity comprising a profit margin component and a cost component;
providing live real-time data feed to the server from an at least one commodities exchange database comprising a set of futures prices for said commodity over a plurality of time periods;
upon detecting a change in the set of futures prices, real-time processing of the set of futures prices and inputs of each of said clients by the server, comprising:
computing a buy price to reseller offer of a buyer to each of said buyer's authorized resellers, the buy price to reseller offer comprising the futures price adjusted by the buyer basis for each of said plurality of time periods;
computing a buy price to seller offer of a reseller to each of said reseller's authorized sellers, comprising the buy price to reseller adjusted by the reseller basis for each of said plurality of time periods;
generating client-specific output from the server in real-time for each of said plurality of time periods comprising:
for each buyer, the set of futures prices, the buyer's basis and the buyer's buy price to reseller offers for each of the buyer's at least one authorized resellers;
for each reseller, the set of buy price to reseller offers for each of the reseller's at least one authorized buyers, the reseller's basis and the reseller's buy price to seller offers for each of the reseller's at least one authorized sellers;
for each seller, the reseller's basis and the set of buy price to seller offers for each of the seller's at least one authorized resellers;
communicating the client-specific output from the server in real-time to each of said clients;
if a reseller or seller who receives an offer accepts the offer, inputting to the server the acceptance of the offer to the originating buyer or reseller; and,
if the originating buyer or reseller receiving the acceptance approves the transaction, completing the transaction;
whereby, authorized buyers, resellers and sellers may automate their business practices so as to generate and receive offers and acceptances in real-time that track changes in the futures price of the commodity and in the buyer and reseller basis so as to optimize client profits and to minimize market risks and the time required to process transactions.

2. The method of claim 1, wherein inputs to the server further comprise inputs of an at least one alarm condition, the at least one alarm condition specifying a condition which, when met, prompts a notification to the client to enable the client to respond.

3. The method of claim 1, wherein inputs to the server further comprise inputs of an at least one automated condition, the at least one automated condition specifying a condition which, when met, prompts a notification to the client and triggers an automated response.

4. The method of claim 1, wherein inputs to the server further comprise inputs of account and demographic data for each of said clients.

5. The method of claim 1, wherein the cost component of the buyer basis may comprise a cost of transportation and a cost of storage.

6. The method of claim 1, wherein the cost component of the reseller basis may comprise a cost of transportation and a cost of storage.

7. The method of claim 1, wherein the buy price to seller is further adjusted to reflect a freight cost to seller so as to generate a buy price to seller picked up.

8. The method of claim 7, further comprising for each seller, the set of buy price to seller picked up offers for each of the seller's at least one authorized resellers.

9. A method for automating price discovery for cash trade in a tangible agricultural commodity in real-time between a network of an at least two clients authorized to conduct business with one another, the method comprising:
providing an at least one server computer in communication with a computer network;
providing input to the server from each of the at least two clients comprising an at least one buyer and an at least one seller, the buyer buying the commodity from the seller, the seller selling the commodity to the buyer, the input comprising:
if the client is a buyer, identification of an at least one authorized seller, namely a seller with whom the buyer authorizes communication and acceptance of offers to buy;
if the client is a seller, identification of an at least one authorized buyer, namely a buyer with whom the seller authorizes communication and acceptance of offers to sell;
processing the input of each of said clients by the server, comprising:
verifying that each of the authorized sellers and buyers agrees to authorize communication and acceptance of offers from their mutually-identified counterpart sellers or buyers;
restricting communication and acceptance of offers to authorized clients only so as to ensure confidentiality of said communications and offers;
providing further input to the server from each of the at least two clients, the input comprising if a client is a buyer, a buyer basis for said commodity comprising a profit margin component and a cost component;
providing live real-time data feed to the server from an at least one commodities exchange database comprising a set of futures prices for said commodity over a plurality of time periods;
upon detecting a change in the set of futures prices, real-time processing of the set of futures prices and inputs of each of said clients by the server, comprising:
computing a buy price to seller offer of a buyer to each of said buyer's authorized sellers, the buy price to seller offer comprising the futures price adjusted by the buyer basis for each of said plurality of time periods;
generating client-specific output from the server in real-time for each of said plurality of time periods comprising:
for each buyer, the set of futures prices, the buyer's basis and the buyer's buy price to seller offers for each of the buyer's at least one authorized sellers;
for each seller, the buyer's basis and the set of buy price to seller offers for each of the seller's at least one authorized buyers;
communicating the client-specific output from the server in real-time to each of said clients;
if a seller who receives an offer accepts the offer, inputting to the server the acceptance of the offer to the originating buyer; and,
if the originating buyer receiving the acceptance approves the transaction, completing the transaction;
whereby, authorized buyers and sellers may automate their business practices so as to generate and receive offers and acceptances in real-time that track changes in the futures price of the commodity and in the buyer basis so as to optimize client profits and to minimize market risks and the time required to process transactions.

10. The method of claim 9, wherein inputs to the server further comprise inputs of an at least one alarm condition, the at least one alarm condition specifying a condition which, when met, prompts a notification to the client to enable the client to respond.

11. The method of claim 9, wherein inputs to the server further comprise in puts of an at least one automated condition, the at least one automated condition specifying a condition which, when met, prompts a notification to the client and triggers an automated response.

12. The method of claim 9, wherein input to the server further comprise inputs of account and demographic data for each of said clients.

13. The method of claim 9, wherein the cost component of the buyer basis may comprise a cost of transportation and a cost of storage.

14. An apparatus for automating price discovery for cash trade in a tangible agricultural commodity in real-time between a network of an at least three clients authorized to conduct business with one another, the apparatus comprising:
means for providing an at least one server computer in communication with a computer network;
means for providing input to the server from each of the at least three clients comprising an at least one buyer, an at least one reseller and an at least one seller, the buyer buying the commodity from the reseller, the reseller buying the commodity from the seller and selling the commodity to the buyer, and the seller selling the commodity to the reseller, the input comprising:
if the client is a buyer, identification of an at least one authorized reseller, namely a reseller with whom the buyer authorizes communication and acceptance of offers to buy;
if the client is a reseller, identification of an at least one authorized seller, namely a seller with whom the reseller authorizes communication and acceptance of offers to buy; and identification of an at least one authorized buyer, namely a buyer with whom the reseller authorizes communication and acceptance of offers to sell;
if the client is a seller, identification of an at least one authorized reseller, namely a reseller with whom the seller authorizes communication and acceptance of offers to sell;
means for processing the input of each of said clients by the server, comprising:
means for verifying that each of the authorized sellers, resellers and buyers agrees to authorize communication and acceptance of offers from their mutually-identified counterpart sellers, resellers or buyers;
means for restricting communication and acceptance of offers to authorized clients only so as to ensure confidentiality of said communications and offers;
means for providing further inputs to the server from each of the at least three clients, the inputs comprising:
if a client is a buyer, a buyer basis for said commodity comprising a profit margin component and a cost component;
if a client is a reseller, a reseller basis for said commodity comprising a profit margin component and a cost component;
means for providing live real-time data feed to the server from an at least one commodities exchange database comprising a set of futures prices for said commodity over a plurality of time periods;
upon detecting a change in the set of futures prices, means for real-time processing of the set of futures prices and inputs of each of said clients by the server, comprising:
means for computing a buy price to reseller offer of a buyer to each of said buyer's authorized resellers, the buy price to reseller offer comprising the futures price adjusted by the buyer basis for each of said plurality of time periods;
means for computing a buy price to seller offer of a reseller to each of said reseller's authorized sellers, comprising the buy price to reseller adjusted by the reseller basis for each of said plurality of time periods;
means for generating client-specific output from the server in real-time for each of said plurality of time periods comprising:
for each buyer, the set of futures prices, the buyer's basis and the buyer's buy price to reseller offers for each of the buyer's at least one authorized resellers;
for each reseller, the set of buy price to reseller offers for each of the reseller's at least one authorized buyers, the reseller's basis and the reseller's buy price to seller offers for each of the reseller's at least one authorized sellers;
for each seller, the reseller's basis and the set of buy price to seller offers for each of the seller's at least one authorized resellers;
means for communicating the client-specific output from the server in real-time to each of said clients;
if a reseller or seller who receives an offer accepts the offer, means for inputting to the server the acceptance of the offer to the originating buyer or reseller; and, if the originating buyer or reseller receiving the acceptance approves the transaction, means for completing the transaction;
whereby, authorized buyers, resellers and sellers may automate their business practices so as to generate and receive offers and acceptances in real-time that track changes in the futures price of the commodity and in the buyer and reseller basis so as to optimize client profits and to minimize market risks and the time required to process transactions.

15. The apparatus of claim 14, wherein inputs to the server further comprise inputs of an at least one alarm condition, the at least one alarm condition specifying a condition which, when met, prompts a notification to the client to enable the client to respond.

16. The apparatus of claim 14, wherein inputs to the server further comprise inputs of an at least one automated condition, the at least one automated condition specifying a condition which, when met, prompts a notification to the client and triggers an automated response.

17. A apparatus for automating price discovery for cash trade in a tangible agricultural commodity in real-time between a network of an at least two clients authorized to conduct business with one another, the apparatus comprising:
means for providing an at least one server computer in communication with a computer network;
means for providing input to the server from each of the at least two clients comprising an at least one buyer and an at least one seller, the buyer buying the commodity from the seller, the seller selling the commodity to the buyer, the input comprising:
if the client is a buyer, identification of an at least one authorized seller, namely a seller with whom the buyer authorizes communication and acceptance of offers to buy;
if the client is a seller, identification of an at least one authorized buyer, namely a buyer with whom the seller authorizes communication and acceptance of offers to sell;
processing the input of each of said clients by the server, comprising:
verifying that each of the authorized sellers and buyers agrees to authorize communication and acceptance of offers from their mutually-identified counterpart sellers or buyers;
means for restricting communication and acceptance of offers to authorized clients only so as to ensure confidentiality of said communications and offers;
means for providing further input to the server from each of the at least two clients, the input comprising if a client is a buyer, a buyer basis for said commodity comprising a profit margin component and a cost component;
means for providing live real-time data feed to the server from an at least one commodities exchange database comprising a set of futures prices for said commodity over a plurality of time periods;
upon detecting a change in the set of futures prices, means for real-time processing of the set of futures prices and inputs of each of said clients by the server, comprising:
means for computing a buy price to seller offer of a buyer to each of said buyer's authorized sellers, the buy price to seller offer comprising the futures price adjusted by the buyer basis for each of said plurality of time periods;
means for generating client-specific output from the server in real-time for each of said plurality of time periods comprising:
for each buyer, the set of futures prices, the buyer's basis and the buyer's buy price to seller offers for each of the buyer's at least one authorized sellers;
for each seller, the buyer's basis and the set of buy price to seller offers for each of the seller's at least one authorized buyers;
means for communicating the client-specific output from the server in real-time to each of said clients;
if a seller who receives an offer accepts the offer, means for inputting to the server the acceptance of the offer to the originating buyer; and,
if the originating buyer receiving the acceptance approves the transaction, means for completing the transaction;
whereby, authorized buyers and sellers may automate their business practices so as to generate and receive offers and acceptances in real-time that track changes in the futures price of the commodity and in the buyer basis so as to optimize client profits and to minimize market risks and the time required to process transactions.

18. The apparatus of claim 17, wherein inputs to the server further comprise inputs of an at least one alarm condition, the at least one alarm condition specifying a condition which, when met, prompts a notification to the client to enable the client to respond.

19. The apparatus of claim 17, wherein inputs to the server further comprise in puts of an at least one automated condition, the at least one automated condition specifying a condition which, when met, prompts a notification to the client and triggers an automated response.

20. A program storage device readable by a machine, tangibly embodying a program of instructions executable by the machine to perform method steps for price discovery for cash trade in a tangible agricultural commodity in real-time between a network of an at least three clients authorized to conduct business with one another, the method steps comprising:
providing an at least one server computer in communication with a computer network;
providing input to the server from each of the at least three clients comprising an at least one buyer, an at least one reseller and an at least one seller, the buyer buying the commodity from the reseller, the reseller buying the commodity from the seller and selling the commodity to the buyer, and the seller selling the commodity to the reseller, the input comprising:
if the client is a buyer, identification of an at least one authorized reseller, namely a reseller with whom the buyer authorizes communication and acceptance of offers to buy;
if the client is a reseller, identification of an at least one authorized seller, namely a seller with whom the reseller authorizes communication and acceptance of offers to buy; and identification of an at least one authorized buyer, namely a buyer with whom the reseller authorizes communication and acceptance of offers to sell;
if the client is a seller, identification of an at least one authorized reseller, namely a reseller with whom the seller authorizes communication and acceptance of offers to sell;
processing the input of each of said clients by the server, comprising:
verifying that each of the authorized sellers, resellers and buyers agrees to authorize communication and acceptance of offers from their mutually-identified counterpart sellers, resellers or buyers;
restricting communication and acceptance of offers to authorized clients only so as to ensure confidentiality of said communications and offers;
providing further inputs to the server from each of the at least three clients, the inputs comprising:
if a client is a buyer, a buyer basis for said commodity comprising a profit margin component and a cost component;
if a client is a reseller, a reseller basis for said commodity comprising a profit margin component and a cost component;
providing live real-time data feed to the server from an at least one commodities exchange database comprising a set of futures prices for said commodity over a plurality of time periods;
upon detecting a change in the set of futures prices, real-time processing of the set of futures prices and inputs of each of said clients by the server, comprising:
computing a buy price to reseller offer of a buyer to each of said buyer's authorized resellers, the buy price to reseller offer comprising the futures price adjusted by the buyer basis for each of said plurality of time periods;
computing a buy price to seller offer of a reseller to each of said reseller's authorized sellers, comprising the buy price to reseller adjusted by the reseller basis for each of said plurality of time periods;
generating client-specific output from the server in real-time for each of said plurality of time periods comprising:
for each buyer, the set of futures prices, the buyer's basis and the buyer's buy price to reseller offers for each of the buyer's at least one authorized resellers;
for each reseller, the set of buy price to reseller offers for each of the reseller's at least one authorized buyers, the reseller's basis and the reseller's buy price to seller offers for each of the reseller's at least one authorized sellers;
for each seller, the reseller's basis and the set of buy price to seller offers for each of the seller's at least one authorized resellers;
communicating the client-specific output from the server in real-time to each of said clients;
if a reseller or seller who receives an offer accepts the offer, inputting to the server the acceptance of the offer to the originating buyer or reseller; and,
if the originating buyer or reseller receiving the acceptance approves the transaction, completing the transaction;
whereby, authorized buyers, resellers and sellers may automate their business practices so as to generate and receive offers and acceptances in real-time that track changes in the futures price of the commodity and in the buyer and reseller basis so as to optimize client profits and to minimize market risks and the time required to process transactions.

21. The program storage device of claim 20, wherein inputs to the server further comprise inputs of an at least one alarm condition, the at least one alarm condition specifying a condition which, when met, prompts a notification to the client to enable the client to respond.

22. The program storage device of claim 20, wherein inputs to the server further comprise inputs of an at least one automated condition, the at least one automated condition specifying a condition which, when met, prompts a notification to the client and triggers an automated response.

23. A program storage device readable by a machine, tangibly embodying a program of instructions executable by the machine to perform method steps for automating price discovery for cash trade in a tangible agricultural commodity in real-time between a network of an at least two clients authorized to conduct business with one another, the method steps comprising:
providing an at least one server computer in communication with a computer network;
providing input to the server from each of the at least two clients comprising an at least one buyer and an at least one seller, the buyer buying the commodity from the seller, the seller selling the commodity to the buyer, the input comprising:
if the client is a buyer, identification of an at least one authorized seller, namely a seller with whom the buyer authorizes communication and acceptance of offers to buy;
if the client is a seller, identification of an at least one authorized buyer, namely a buyer with whom the seller authorizes communication and acceptance of offers to sell;
processing the input of each of said clients by the server, comprising:
verifying that each of the authorized sellers and buyers agrees to authorize communication and acceptance of offers from their mutually-identified counterpart sellers or buyers;
restricting communication and acceptance of offers to authorized clients only so as to ensure confidentiality of said communications and offers;
providing further input to the server from each of the at least two clients, the input comprising if a client is a buyer, a buyer basis for said commodity comprising a profit margin component and a cost component;
providing live real-time data feed to the server from an at least one commodities exchange database comprising a set of futures prices for said commodity over a plurality of time periods;
upon detecting a change in the set of futures prices, real-time processing of the set of futures prices and inputs of each of said clients by the server, comprising:
computing a buy price to seller offer of a buyer to each of said buyer's authorized sellers, the buy price to seller offer comprising the futures price adjusted by the buyer basis for each of said plurality of time periods;
generating client-specific output from the server in real-time for each of said plurality of time periods comprising:
for each buyer, the set of futures prices, the buyer's basis and the buyer's buy price to seller offers for each of the buyer's at least one authorized sellers;
for each seller, the buyer's basis and the set of buy price to seller offers for each of the seller's at least one authorized buyers;
communicating the client-specific output from the server in real-time to each of said clients;
if a seller who receives an offer accepts the offer, inputting to the server the acceptance of the offer to the originating buyer; and,
if the originating buyer receiving the acceptance approves the transaction, completing the transaction;
whereby, authorized buyers and sellers may automate their business practices so as to generate and receive offers and acceptances in real-time that track changes in the futures price of the commodity and in the buyer basis so as to optimize client profits and to minimize market risks and the time required to process transactions.

24. The program storage device of claim 23, wherein inputs to the server further comprise inputs of an at least one alarm condition, the at least one alarm condition specifying a condition which, when met, prompts a notification to the client to enable the client to respond.

25. The program storage device of claim 23, wherein inputs to the server further comprise in puts of an at least one automated condition, the at least one automated condition specifying a condition which, when met, prompts a notification to the client and triggers an automated response.

26. An article of manufacture comprising a computer-usable medium having computer-readable program code means embodied in said medium for automating price discovery for cash trade in a tangible agricultural commodity in real-time between a network of an at least three clients authorized to conduct business with one another, the computer-readable program code means comprising:
computer readable program code means for providing an at least one server computer in communication with a computer network;
computer readable program code means for providing input to the server from each of the at least three clients comprising an at least one buyer, an at least one reseller and an at least one seller, the buyer buying the commodity from the reseller, the reseller buying the commodity from the seller and selling the commodity to the buyer, and the seller selling the commodity to the reseller, the input comprising:
if the client is a buyer, identification of an at least one authorized reseller, namely a reseller with whom the buyer authorizes communication and acceptance of offers to buy;
if the client is a reseller, identification of an at least one authorized seller, namely a seller with whom the reseller authorizes communication and acceptance of offers to buy; and identification of an at least one authorized buyer, namely a buyer with whom the reseller authorizes communication and acceptance of offers to sell;
if the client is a seller, identification of an at least one authorized reseller, namely a reseller with whom the seller authorizes communication and acceptance of offers to sell;
processing the input of each of said clients by the server, comprising:
verifying that each of the authorized sellers, resellers and buyers agrees to authorize communication and acceptance of offers from their mutually-identified counterpart sellers, resellers or buyers;
restricting communication and acceptance of offers to authorized clients only so as to ensure confidentiality of said communications and offers;
computer readable program code means for providing further inputs to the server from each of the at least three clients, the inputs comprising:
if a client is a buyer, a buyer basis for said commodity comprising a profit margin component and a cost component;
if a client is a reseller, a reseller basis for said commodity comprising a profit margin component and a cost component;
computer readable program code means for providing live real-time data feed to the server from an at least one commodities exchange database comprising a set of futures prices for said commodity over a plurality of time periods;
upon detecting a change in the set of futures prices, computer readable program code means for real-time processing of the set of futures prices and inputs of each of said clients by the server, comprising:
computer readable program code means for computing a buy price to reseller offer of a buyer to each of said buyer's authorized resellers, the buy price to reseller offer comprising the futures price adjusted by the buyer basis for each of said plurality of time periods;
computer readable program code means for computing a buy price to seller offer of a reseller to each of said reseller's authorized sellers, comprising the buy price to reseller adjusted by the reseller basis for each of said plurality of time periods;
computer readable program code means for generating client-specific output from the server in real-time for each of said plurality of time periods comprising:
for each buyer, the set of futures prices, the buyer's basis and the buyer's buy price to reseller offers for each of the buyer's at least one authorized resellers;
for each reseller, the set of buy price to reseller offers for each of the reseller's at least one authorized buyers, the reseller's basis and the reseller's buy price to seller offers for each of the reseller's at least one authorized sellers;
for each seller, the reseller's basis and the set of buy price to seller offers for each of the seller's at least one authorized resellers;
computer readable program code means for communicating the client-specific output from the server in real-time to each of said clients;
if a reseller or seller who receives an offer accepts the offer, computer readable program code means for inputting to the server the acceptance of the offer to the originating buyer or reseller; and,
if the originating buyer or reseller receiving the acceptance approves the transaction, computer readable program code means for completing the transaction;
whereby, authorized buyers, resellers and sellers may automate their business practices so as to generate and receive offers and acceptances in real-time that track changes in the futures price of the commodity and in the buyer and reseller basis so as to optimize client profits and to minimize market risks and the time required to process transactions.

27. The article of manufacture of claim 26, wherein inputs to the server further comprise inputs of an at least one alarm condition, the at least one alarm condition specifying a condition which, when met, prompts a notification to the client to enable the client to respond.

28. The article of manufacture of 26, wherein inputs to the server further comprise inputs of an at least one automated condition, the at least one automated condition specifying a condition which, when met, prompts a notification to the client and triggers an automated response.

29. An article of manufacture comprising a computer-usable medium having computer-readable program code means embodied in said medium for automating price discovery for cash trade in a tangible agricultural commodity in real-time between a network of an at least two clients authorized to conduct business with one another, the computer-readable program code means comprising:
computer readable program code means for providing an at least one server computer in communication with a computer network;
computer readable program code means for providing input to the server from each of the at least two clients comprising an at least one buyer and an at least one seller, the buyer buying the commodity from the seller, the seller selling the commodity to the buyer, the input comprising:
if the client is a buyer, identification of an at least one authorized seller, namely a seller with whom the buyer authorizes communication and acceptance of offers to buy;
if the client is a seller, identification of an at least one authorized buyer, namely a buyer with whom the seller authorizes communication and acceptance of offers to sell;
computer readable program code means for processing the input of each of said clients by the server, comprising:
computer readable program code means for verifying that each of the authorized sellers and buyers agrees to authorize communication and acceptance of offers from their mutually-identified counterpart sellers or buyers;
computer readable program code means for restricting communication and acceptance of offers to authorized clients only so as to ensure confidentiality of said communications and offers;
computer readable program code means for providing further input to the server from each of the at least two clients, the input comprising if a client is a buyer, a buyer basis for said commodity comprising a profit margin component and a cost component;
computer readable program code means for providing live real-time data feed to the server from an at least one commodities exchange database comprising a set of futures prices for said commodity over a plurality of time periods;
upon detecting a change in the set of futures prices, computer readable program code means for real-time processing of the set of futures prices and inputs of each of said clients by the server, comprising:
computer readable program code means for computing a buy price to seller offer of a buyer to each of said buyer's authorized sellers, the buy price to seller offer comprising the futures price adjusted by the buyer basis for each of said plurality of time periods;
computer readable program code means for generating client-specific output from the server in real-time for each of said plurality of time periods comprising:
for each buyer, the set of futures prices, the buyer's basis and the buyer's buy price to seller offers for each of the buyer's at least one authorized sellers;
for each seller, the buyer's basis and the set of buy price to seller offers for each of the seller's at least one authorized buyers;
computer readable program code means for communicating the client-specific output from the server in real-time to each of said clients;
if a seller who receives an offer accepts the offer, computer readable program code means for inputting to the server the acceptance of the offer to the originating buyer; and,
if the originating buyer receiving the acceptance approves the transaction, computer readable program code means for completing the transaction;
whereby, authorized buyers and sellers may automate their business practices so as to generate and receive offers and acceptances in real-time that track changes in the futures price of the commodity and in the buyer basis so as to optimize client profits and to minimize market risks and the time required to process transactions.

30. The article of manufacture of 29, wherein inputs to the server further comprise inputs of an at least one alarm condition, the at least one alarm condition specifying a condition which, when met, prompts a notification to the client to enable the client to respond.

31. The article of manufacture of 29, wherein inputs to the server further comprise in puts of an at least one automated condition, the at least one automated condition specifying a condition which, when met, prompts a notification to the client and triggers an automated response.

32. A computer program product comprising:
a computer usable medium and computer readable code embodied on said computer useable medium for causing the automating of price discovery for cash trade in a tangible agricultural commodity in real-time between a network of an at least three clients authorized to conduct business with one another, the computer readable code comprising:
computer readable program code devices configured to cause the computer to effect the providing of an at least one server computer in communication with a computer network;
computer readable program code devices configured to cause the computer to effect the providing of input to the server from each of the at least three clients comprising an at least one buyer, an at least one reseller and an at least one seller, the buyer buying the commodity from the reseller, the reseller buying the commodity from the seller and selling the commodity to the buyer, and the seller selling the commodity to the reseller, the input comprising:
if the client is a buyer, identification of an at least one authorized reseller, namely a reseller with whom the buyer authorizes communication and acceptance of offers to buy;
if the client is a reseller, identification of an at least one authorized seller, namely a seller with whom the reseller authorizes communication and acceptance of offers to buy; and identification of an at least one authorized buyer, namely a buyer with whom the reseller authorizes communication and acceptance of offers to sell;
if the client is a seller, identification of an at least one authorized reseller, namely a reseller with whom the seller authorizes communication and acceptance of offers to sell;
computer readable program code devices configured to cause the computer to effect the processing of the input of each of said clients by the server, comprising:
computer readable program code devices configured to cause the computer to effect the verifying of that each of the authorized sellers, resellers and buyers agrees to authorize communication and acceptance of offers from their mutually-identified counterpart sellers, resellers or buyers;
computer readable program code devices configured to cause the computer to effect the restricting of communication and acceptance of offers to authorized clients only so as to ensure confidentiality of said communications and offers;
computer readable program code devices configured to cause the computer to effect the providing of further inputs to the server from each of the at least three clients, the inputs comprising:
if a client is a buyer, a buyer basis for said commodity comprising a profit margin component and a cost component;
if a client is a reseller, a reseller basis for said commodity comprising a profit margin component and a cost component;
computer readable program code devices configured to cause the computer to effect the providing of live real-time data feed to the server from an at least one commodities exchange database comprising a set of futures prices for said commodity over a plurality of time periods;
upon detecting a change in the set of futures prices, computer readable program code devices configured to cause the computer to effect the real-time processing of the set of futures prices and inputs of each of said clients by the server, comprising:
computer readable program code devices configured to cause the computer to effect the computing of a buy price to reseller offer of a buyer to each of said buyer's authorized resellers, the buy price to reseller offer comprising the futures price adjusted by the buyer basis for each of said plurality of time periods;
computer readable program code devices configured to cause the computer to effect the computing of a buy price to seller offer of a reseller to each of said reseller's authorized sellers, comprising the buy price to reseller adjusted by the reseller basis for each of said plurality of time periods;
computer readable program code devices configured to cause the computer to effect the generating of client-specific output from the server in real-time for each of said plurality of time periods comprising:
for each buyer, the set of futures prices, the buyer's basis and the buyer's buy price to reseller offers for each of the buyer's at least one authorized resellers;
for each reseller, the set of buy price to reseller offers for each of the reseller's at least one authorized buyers, the reseller's basis and the reseller's buy price to seller offers for each of the reseller's at least one authorized sellers;
for each seller, the reseller's basis and the set of buy price to seller offers for each of the seller's at least one authorized resellers;
computer readable program code devices configured to cause the computer to effect the communicating pf the client-specific output from the server in real-time to each of said clients;
if a reseller or seller who receives an offer accepts the offer, computer readable program code devices configured to cause the computer to effect the inputting to the server of the acceptance of the offer to the originating buyer or reseller; and,
if the originating buyer or reseller receiving the acceptance approves the transaction, computer readable program code devices configured to cause the computer to effect the completing of the transaction;
whereby, authorized buyers, resellers and sellers may automate their business practices so as to generate and receive offers and acceptances in real-time that track changes in the futures price of the commodity and in the buyer and reseller basis so as to optimize client profits and to minimize market risks and the time required to process transactions.

33. The computer program product of claim 32, wherein inputs to the server further comprise inputs of an at least one alarm condition, the at least one alarm condition specifying a condition which, when met, prompts a notification to the client to enable the client to respond.

34. The computer program product of claim 32, wherein inputs to the server further comprise inputs of an at least one automated condition, the at least one automated condition specifying a condition which, when met, prompts a notification to the client and triggers an automated response.

35. A computer program product comprising:
a computer usable medium and computer readable code embodied on said computer useable medium for causing the automating of price discovery for cash trade in a tangible agricultural commodity in real-time between a network of an at least two clients authorized to conduct business with one another, the computer readable code comprising:
providing an at least one server computer in communication with a computer network;
providing input to the server from each of the at least two clients comprising an at least one buyer and an at least one seller, the buyer buying the commodity from the seller, the seller selling the commodity to the buyer, the input comprising:
if the client is a buyer, identification of an at least one authorized seller, namely a seller with whom the buyer authorizes communication and acceptance of offers to buy;
if the client is a seller, identification of an at least one authorized buyer, namely a buyer with whom the seller authorizes communication and acceptance of offers to sell;
processing the input of each of said clients by the server, comprising:
verifying that each of the authorized sellers and buyers agrees to authorize communication and acceptance of offers from their mutually-identified counterpart sellers or buyers;
restricting communication and acceptance of offers to authorized clients only so as to ensure confidentiality of said communications and offers;
providing further input to the server from each of the at least two clients, the input comprising if a client is a buyer, a buyer basis for said commodity comprising a profit margin component and a cost component;
providing live real-time data feed to the server from an at least one commodities exchange database comprising a set of futures prices for said commodity over a plurality of time periods;
upon detecting a change in the set of futures prices, real-time processing of the set of futures prices and inputs of each of said clients by the server, comprising:
computing a buy price to seller offer of a buyer to each of said buyer's authorized sellers, the buy price to seller offer comprising the futures price adjusted by the buyer basis for each of said plurality of time periods;
generating client-specific output from the server in real-time for each of said plurality of time periods comprising:
for each buyer, the set of futures prices, the buyer's basis and the buyer's buy price to seller offers for each of the buyer's at least one authorized sellers;
for each seller, the buyer's basis and the set of buy price to seller offers for each of the seller's at least one authorized buyers;
communicating the client-specific output from the server in real-time to each of said clients;
if a seller who receives an offer accepts the offer, inputting to the server the acceptance of the offer to the originating buyer; and,
if the originating buyer receiving the acceptance approves the transaction, completing the transaction;
whereby, authorized buyers and sellers may automate their business practices so as to generate and receive offers and acceptances in real-time that track changes in the futures price of the commodity and in the buyer basis so as to optimize client profits and to minimize market risks and the time required to process transactions.

36. The computer program product of claim 35, wherein inputs to the server further comprise inputs of an at least one alarm condition, the at least one alarm condition specifying a condition which, when met, prompts a notification to the client to enable the client to respond.

37. The computer program product of claim 35, wherein inputs to the server further comprise in puts of an at least one automated condition, the at least one automated condition specifying a condition which, when met, prompts a notification to the client and triggers an automated response.
